(19) United States
(12) Patent Application Publication
(10) Pub. No.: US 2007/0198566 A1
(43) Pub. Date: Aug. 23, 2007

(54) Method and apparatus for efficient storage of hierarchical signal names

(76) Inventor: Matyas Sustik, Austin, TX (US)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(21) Appl. No.: 11/360,905

(22) Filed: Feb. 23, 2006

(51) Int. Cl. G06F 7/00

(52) U.S. Cl. 707/102

(57) ABSTRACT

A method, computer program product, and data processing system for efficiently storing a set of hierarchically-specified names in a modular hardware design are disclosed. In accordance with a preferred embodiment of the present invention, a data structure for storing the names is built from a master trie. The master trie is used to store names of instances of modules contained within the design. The node in the master trie corresponding to a particular instance name is associated with an additional trie (“class trie”) corresponding to the class of module to which that instance belongs. In this additional trie are stored the names of the individual signals associated with that class of module. Where there are multiple instances of the same class of module within a design, each instance name may be associated with a single class trie storing each of the individual signal names associated with that class of module.

### BACKGROUND OF THE INVENTION

1. Technical Field

The present invention relates generally to methods to store collections of string data. Specifically, the present invention is directed to a technique for rapid and efficient storage and retrieval of hierarchical names having repeated components, such as signal names in an electronic circuit design.

2. Description of the Related Art

There are many data processing applications which require the storage and retrieval of a set of strings or of data items that are indexed by strings. In many such applications, it is essential that such strings be retrieved very rapidly. A spell-checking program, for example, relies on the ability to rapidly determine whether an arbitrary string exists in the program's dictionary.

Most common data structures have a search/retrieval time that grows asymptotically with the number of data items in the structure. For example, a balanced binary tree has an O(logn) expected search time, where n is the number of items in the data structure. As the number of items in a binary tree increases, the expected search time increases logarithmically.

Where data is represented as strings, however, there is an additional level of complexity in that the data item(s) being searched for are of non-trivial length. In a binary search tree containing string keys, for example, each time a node in the tree is visited, the string being searched for must be compared, generally character by character, with the key contained within that node. As a practical matter, this makes the expected number of per-character comparisons O(klogn), which may be significant in the case of a large k or large n.

One alternative to a comparison-based search that may significantly improve search performance is to use a hash table. A hash table is a data structure in which items are pseudo-randomly distributed across a sparse array by using a hash function to map a given key to a location in the table. A well-constructed hash table may be capable of obtaining an O(k) expected search time. Hash tables suffer from a number of disadvantages that make them unsuitable for certain applications, however. First, well-constructed hash tables may be difficult to attain, since the performance of a hash table depends on the quality of the hash function used to construct the table, as well as the relative sparseness of the table itself (since crowded tables are likely to result in performance-degrading collisions between data items). Second, hash tables do not permit an efficient enumeration of all of the data items contained in the table, since a well-constructed hash table is generally sparsely populated with data items. Third, the pseudo-random nature of hash-table storage means that items in a hash table are stored out of order; thus, it is generally not possible to enumerate the items stored in a hash table in lexicographical order directly from the hash table itself.

Another data structure that can be employed for string searching and retrieval is commonly referred to as a “trie” (pronounced “try”) but is also frequently referred to as a “radix tree.” The “trie” first appeared in a 1961 article by Edward Fredkin under the name “trie memory.” Fredkin, E. “Trie Memory,” Communications of the ACM, vol. 3, no. 9 (September 1961), pp. 490-500. The name “trie” is apparently derived from the word “retrieval.”

A trie is a search tree in which each edge represents a character in one or more keys stored in the trie. The search path taken through a trie to find a given key is determined by each individual character in that key. For example, consider trie 100 in FIG. 1. Trie 100 stores a number of different words (strings), including “dab,” “bad,” “bade,” “bed,” “be,” “bead,” “cab,” “cad,” and “a.” Looking up a key in trie 100 consists of traversing the trie starting at root node 102 and following, in succession, the edges corresponding to the characters in the key to be looked up.

For example, to look up the word “dab,” the traversal begins at root node 102, follows edge 104 (corresponding to the character “d”) to node 106, follows edge 108 (corresponding to the character “a”) to node 110, and finally follows edge 112 (corresponding to the character “b”) to node 114. Node 114 is shown here as a double circle, which denotes the fact that node 114 represents the end of a word stored in trie 100. It is necessary to distinguish in this manner nodes such as node 114, which end strings stored in trie 100, from other nodes, since a node representing the end of a string stored in trie 100 need not be a leaf node. For example, node 116, which is not a leaf node, represents the end of the string “bad,” which is stored in trie 100. Node 116 is not a leaf node, however, since the string “bad” is a prefix of another string “bade” (denoted by node 118) that is stored in trie 100.

Because of the manner in which they are constructed, tries have path lengths that are proportional to the lengths of the keys stored in the trie. For this reason, the expected search time for a trie is O(k). Further, it is relatively straightforward to implement the trie in such a way that a trie such as trie 100 can be traversed in lexicographical order. Hence, it is also a straightforward procedure to enumerate all keys stored in the trie in lexicographical order.

There are many different variations on the basic trie described in FIG. 1. Certain trie implementations attempt to compress the size of the trie and/or balance the trie as one would balance a binary search tree. FIG. 2, for example, depicts what is known as a PATRICIA trie 200. PATRICIA, an acronym for “Practical Algorithm to Retrieve Information Coded in Alphanumeric,” is the name of a trie data structure in which non-branching paths are compressed to save space and/or reduce search times. The PATRICIA data structure was first described in Morrison, D.R. “PATRICIA-Practical Algorithm to Retrieve Information Coded in Alphanumeric,” J. ACM, vol. 15, no. 4 (October 1968), pp. 514-534. In Patricia trie 200, the search path from root node 202 to node 206 (denoting the stored string “dab”) consists of a single edge 204, as opposed to the three cascaded edges in corresponding trie 100 depicted in FIG. 1. PATRICIA tries are commonly employed for storing strings used in dictionary-based data compression and for storing entries in network routing tables.

In certain circumstances, however, even PATRICIA tries may exhibit a large amount of redundancy. For example, in a hierarchical electronic hardware design, certain modular components of the design will be used repeatedly across the design. In these circumstances, there are certain signal names that are duplicated from instance to instance of a particular class of module. Each instance of a flip-flop module, for example, might have an output signal called “Q.” If we prepend each individual instance of that signal with an instance name corresponding to the instance of that module, each individual “Q” signal will have a unique name. However, since each individual signal name is prefixed by an instance name, if we were to build a trie containing all of these unique names, we would have to have a separate “Q” entry in the trie for each instance of a module having a signal name “Q” in it. The result of this is that whole sets of signal names are copied repeatedly throughout the trie.

What is needed, therefore, is a space-efficient data structure that supports rapid insertion, search, and deletion of hierarchical signal names as well as alphabetical signal name retrieval. The present invention provides a solution to this and other problems, and offers other advantages over previous solutions.

### SUMMARY OF THE INVENTION

Accordingly, the present invention provides a method, computer program product, and data processing system for efficiently storing a set of hierarchically-specified names in a modular hardware design, such as the design of a microprocessor, for example. In accordance with the preferred embodiment of the present invention, a data structure for storing the names is built from a master trie. The master trie is used to store names of instances of modules contained within the design. The node in the master trie corresponding to a particular instance name is associated with an additional trie (“class trie”) corresponding to the class of module to which that instance belongs. In this additional trie are stored the names of the individual signals associated with that class of module. Where there are multiple instances of the same class of module within a design, each instance name may be associated with a single class trie storing each of the individual signal names associated with that class of module. This allows the performance advantages of trie data structures to be enjoyed while minimizing memory usage, particularly for highly repetitive sets of names.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram of a trie data structure;

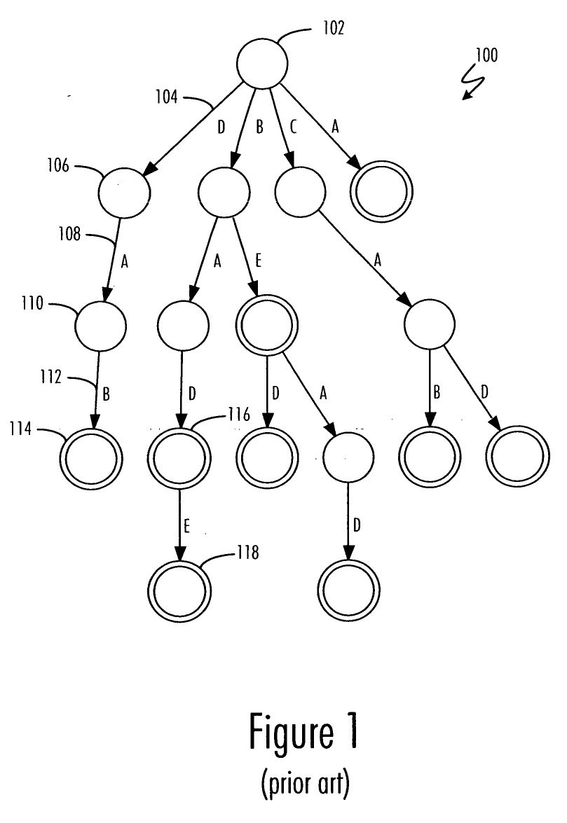

FIG. 2 is a diagram of a PATRICIA trie;

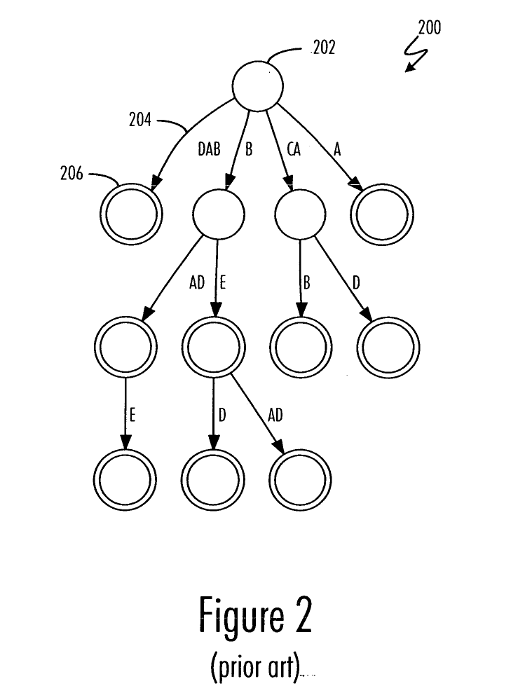

FIG. 3 is a diagram illustrating a circuit design having hierarchical names that may be stored in a trie-based data structure in accordance with a preferred embodiment of the present invention;

FIG. 4 is a diagram illustrating a process of transforming a hardware definition into a hardware model in accordance with a preferred embodiment of the present invention;

FIG. 5 is a diagram of a trie-based data structure utilized in a preferred embodiment of the present invention;

FIG. 6 is a flowchart representation of a process of inserting an instance of a design module into a trie-based data structure in accordance with a preferred embodiment of the present invention; and

FIG. 7 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

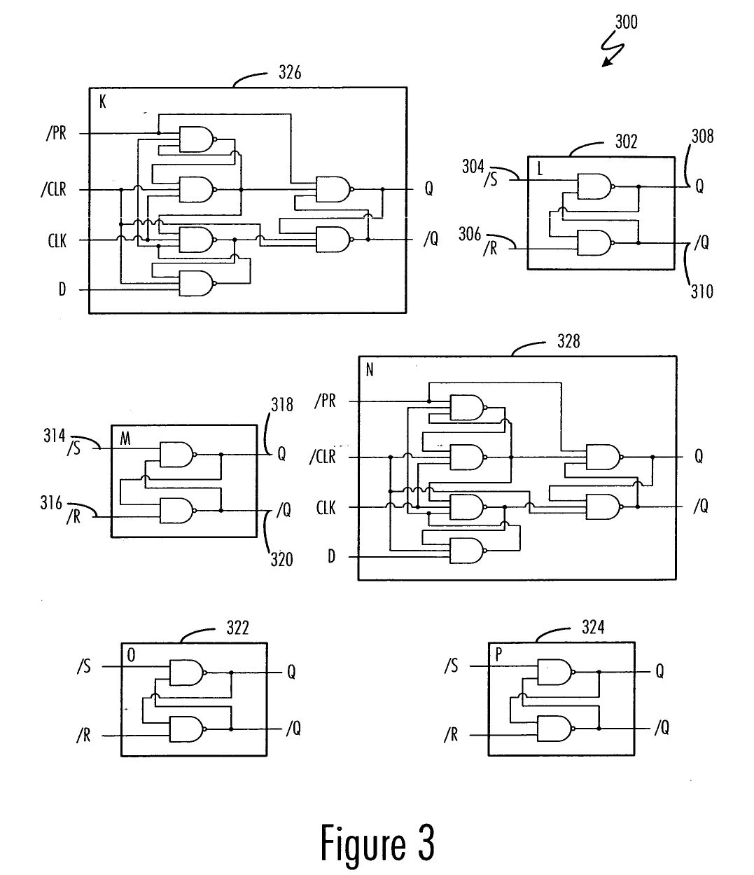

A preferred embodiment of the present invention is directed to the problem of storing a collection of signal names in a hierarchical, modular hardware design. To illustrate what is meant by a hierarchical, modular hardware design, FIG. 3 is a diagram illustrating portions of a circuit design 300 having hierarchical names that may be stored in a trie-based data structure in accordance with a preferred embodiment of the present invention. Circuit design 300 comprises a number of circuit modules 302, 312, 322, 324, 326, and 328. Each of these circuit modules is a subcircuit all of the overall hardware design. Each individual module has a number of input and output signals associated with it.

For example, module 302 is a set-reset latch (or “SR latch”). More specifically, module 302 is a single instance of a set-reset latch. Module 302 is labeled with the instance name “L.” Module 302 has set and reset input signals named /S and /R (inputs 304 and 306, respectively). Similarly, module 302 has complementary outputs 308 and 310. Each other instance of this class of modules (i.e., set-reset latches) has identically named input and output signals. For instance, module 312 has /S and /R inputs 314 and 316, respectively, as well as complementary outputs 318 and 320, just as module 302. Modules 322 and 324, also set-reset latches, have similarly named signals.

Each individual instance of a signal, however, may be denoted by a combination of the instance name for that particular module and the class-related name for the signal in question. For instance, the primary output “Q” for module 302 may be denoted “L.Q,” since “L” is the instance name for module 302 and “Q” is the class-related signal name for the signal in question.

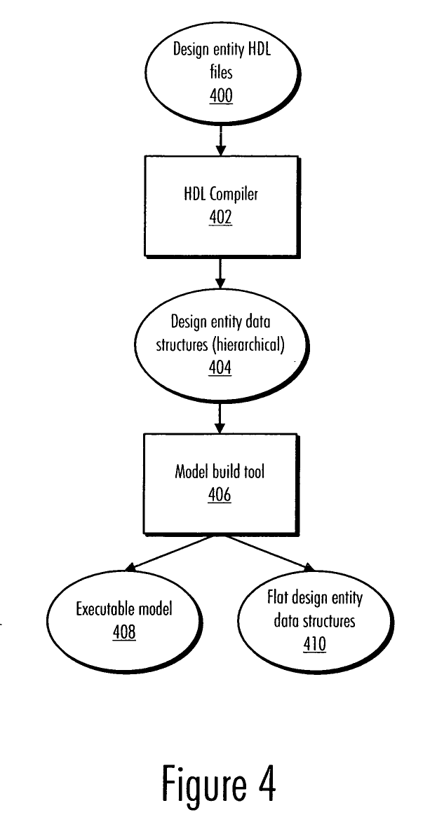

The ability to define instance-specific signal names in terms of hierarchical name components is important in light of an automated process, employed in a preferred embodiment of the present invention, for transforming a hardware definition into a hardware model. This process is depicted in FIG. 4. According to this process, a hardware design is first specified by creating one or more files in a hardware description language (HDL) 400. These files are processed by a hardware description language compiler 402 to obtain hierarchical design entity data structures 404, which represent the design in terms of the hierarchy of modular hardware components. Hierarchical structures 404 are then processed by a model build tool 406, which creates an executable model 408 of the hardware design.

In the process of creating this model, the hierarchical structure of the design is flattened to obtain a nonhierarchical design entity in which each signal is given a unique name. Data structures corresponding to this flattened design entity (data structures 410) include a representation of the set of signal names in the flattened design. A preferred embodiment of the present invention utilizes a composite data structure comprised of multiple trie data structures to store this set of signal names in the flattened design entity.

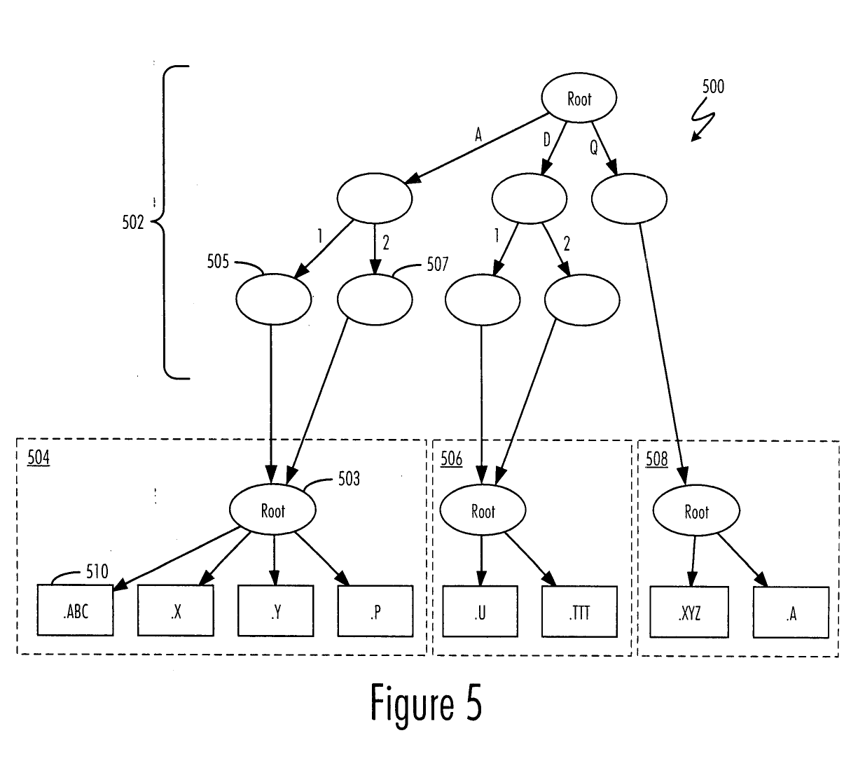

FIG. 5 is a diagram of this trie-based data structure (data structure 500). Data structure 500 is comprised both a master trie 502 and several auxiliary “class tries” 504, 506, and 508. Master trie 502 is used to store the names of module instances in the design. For instance, node 505 corresponds to the instance name “A1.” These instance names are associated with their corresponding class-related signal names by causing the node corresponding to a particular instance name to point to the root node of a class trie corresponding to that class to which the named instance belongs.

For example, in FIG. 5, node 505 points to root node 503 of class trie 504. Class trie 504 corresponds to the class of module to which the instance named “A1” (denoted by node 505) belongs. The names of individual signals (e.g., signal name 510) defined by that class of module are stored in class trie 504. (Note that in FIG. 5 we use rectangles to abbreviate a trie search path corresponding to a given signal name, e.g., signal name 510). This combination of tries permits each individual signal name in the flattened design to be retrieved by traversing the combined data structure, data structure 500.

Significant savings in memory space are obtained by virtue of the fact that multiple nodes in master trie 502 may be associated with a single class trie corresponding to the appropriate class for the module instances represented by those notes. For example, both node 505 and node 507 point to root node 503 of class trie 504, thus permitting the nodes of class trie 504 to be used for representing the individual signal names of both instance “A1” and instance “A2” (represented by nodes 505 and 507, respectively). Hence, signal name 510 in class trie 504 uses the same memory locations to represent both the individual signal name “A1.XYZ” and the individual signal name “A2.XYZ.” This can provide a significant savings in terms of the number of trie nodes needed to represent a complex hierarchical design.

Further savings may be obtained by allowing class tries to point to sub-module tries in a nested fashion. For example, a latch circuit that is made up of NAND gates may have a class trie that contains nodes that point to a NAND-gate trie that stores the signal names associated with an individual NAND gate. One skilled in the art will recognize that an arbitrary number of nesting levels may be utilized in this fashion.

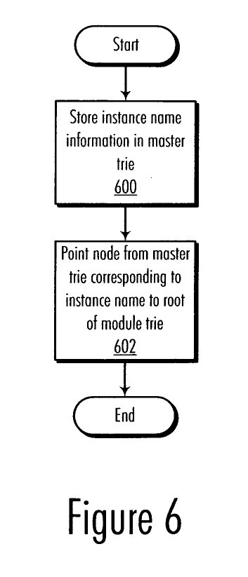

FIG. 6 is a flowchart representation summarizing a process of inserting an instance of a design module into a trie-based data structure in accordance with a preferred embodiment of the present invention. The name of the module instance is inserted into the master trie (block 600). This permits prefix searching on the instance name. Once the module instance name has been inserted into the master trie, the node in the master trie corresponding to that instance name is made to point to the root of a module trie corresponding to the type or class of module of which the current module is an instance (block 602). This completes the insertion to the full data structure of all identifier names corresponding to that module instance.

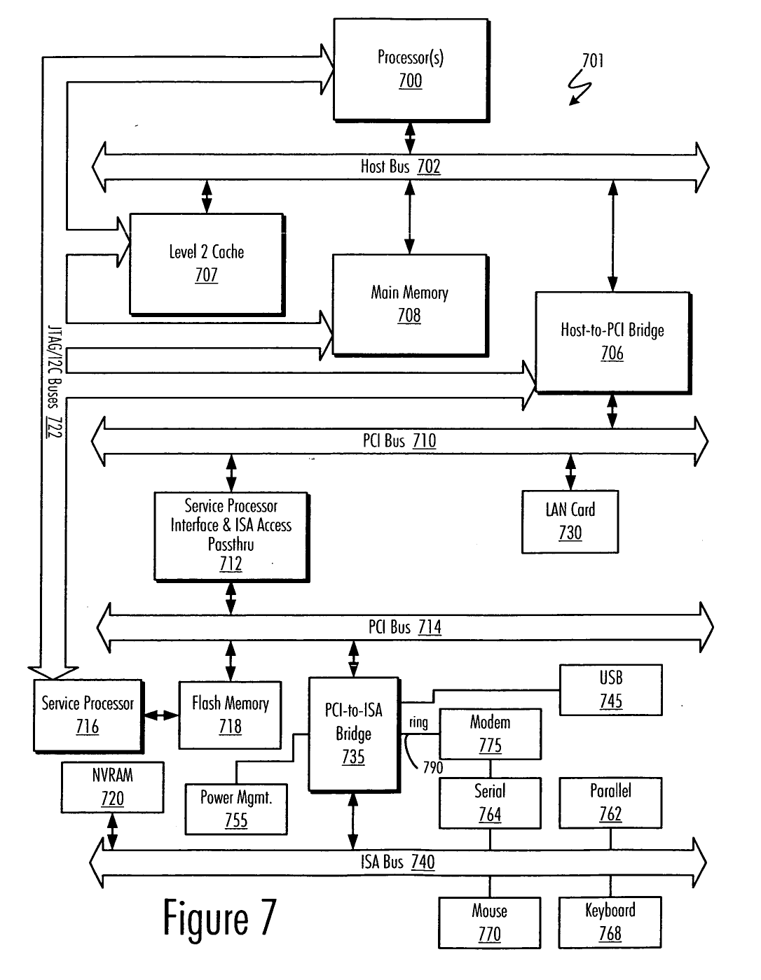

FIG. 7 illustrates information handling system 701, which is a simplified example of a computer system capable of performing the computing operations described herein with respect to a preferred embodiment of the present invention. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PC! bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C buses 722 for communication with processor(s) 700 during initialization steps. JTAG/I2C buses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of supporting the methods described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-implemented method comprising:
inserting an instance name into a first trie, wherein inserting the instance name results in a particular node in the trie corresponding to the instance name; and
associating said particular node with a second trie by causing said particular node to point to a root node of the second trie.

2. The method of claim 1, wherein the instance name corresponds to an instance of a class of objects and the second trie corresponds to said class.

3. The method of claim 2, wherein said class corresponds to a class of modular components in a hardware design.

4. The method of claim 3, wherein the second trie comprises signal names associated with individual signals related to said class.

5. The method of claim 1, further comprising:
inserting a second instance name into the first trie, wherein inserting the instance name results in an additional node in the trie corresponding to the second instance name; and
associating the additional node with the second trie by causing the additional node to point to the root node of the second trie.

6. The method of claim 1, further comprising:
enumerating a plurality of individual signal names from at least the first trie and associated second trie, wherein each of the individual signal names is composed of a corresponding instance name combined with a signal name denoting a signal belonging to a class related to said corresponding instance name.

7. The method of claim 1, further comprising:
inserting a subcomponent name in the second trie; and
associating a third trie with the subcomponent name in the second trie.

8. A computer program product in a computer readable medium comprising functional descriptive material that, when executed by a computer, causes the computer to perform actions that include:
inserting an instance name into a first trie, wherein inserting the instance name results in a particular node in the trie corresponding to the instance name; and
associating said particular node with a second trie by causing said particular node to point to a root node of the second trie.

9. The computer program product of claim 8, wherein the instance name corresponds to an instance of a class of objects and the second trie corresponds to said class.

10. The computer program product of claim 9, wherein said class corresponds to a class of modular components in a hardware design.

11. The computer program product of claim 10, wherein the second trie comprises signal names associated with individual signals related to said class.

12. The computer program product of claim 8, comprising additional functional descriptive material that, when executed by the computer, causes the computer to perform additional actions that include:
inserting a second instance name into the first trie, wherein inserting the instance name results in an additional node in the trie corresponding to the second instance name; and
associating the additional node with the second trie by causing the additional node to point to the root node of the second trie.

13. The computer program product of claim 8, comprising additional functional descriptive material that, when executed by the computer, causes the computer to perform additional actions that include:
enumerating a plurality of individual signal names from at least the first trie and associated second trie, wherein each of the individual signal names is composed of a corresponding instance name combined with a signal name denoting a signal belonging to a class related to said corresponding instance name.

14. The computer program product of claim 8, comprising additional functional descriptive material that, when executed by the computer, causes the computer to perform additional actions that include:
inserting a subcomponent name in the second trie; and
associating a third trie with the subcomponent name in the second trie.

15. A data processing system comprising:
at least one processor;
storage associated with the at least one processor; and
a set of instructions in the storage, wherein the at least one processor executes the set of instructions to perform actions that include:
inserting an instance name into a first trie, wherein inserting the instance name results in a particular node in the trie corresponding to the instance name; and
associating said particular node with a second trie by causing said particular node to point to a root node of the second trie.

16. The data processing system of claim 15, wherein the instance name corresponds to an instance of a class of objects and the second trie corresponds to said class.

17. The data processing system of claim 16, wherein said class corresponds to a class of modular components in a hardware design.

18. The data processing system of claim 17, wherein the second trie comprises signal names associated with individual signals related to said class.

19. The data processing system of claim 15, wherein the at least one processor executes the set of instructions to perform additional acts that include:
inserting a second instance name into the first trace, wherein inserting the instance name results in an additional node in the trie corresponding to the second instance name; and
associating the additional node with the second trie by causing the additional node to point to the root node of the second trie.

20. The data processing system of claim 15, wherein the at least one processor executes the set of instructions to perform additional acts that include:
enumerating a plurality of individual signal names from at least the first trie and associated second trie, wherein each of the individual signal names is composed of a corresponding instance name combined with a signal name denoting a signal belonging to a class related to said corresponding instance name.
